(19) United States
(12) Patent Application Publication
(10) Pub. No.: US 2018/0321663 A1
(43) Pub. Date: Nov. 8, 2018

(54) DATA-ANALYTIC APPROACH TO IDENTIFYING AND PRIORITIZING DELAY-CONTRIBUTING MANUFACTURING JOBS

(71) Applicant: The Boeing Company, Chicago, IL (US)

(72) Inventors: Oscar Kipersztok, Redmond, WA (US); Paul J. Schachter, Seattle, WA (US); Uri Nodelman, Baltimore, MD (US); Michael L. Callaghan, Everett, WA (US)

(21) Appl. No.: 15/584,879

(22) Filed: May 2, 2017

(51) Int. Cl. G05B 19/418; G06Q 10/06

(52) U.S. Cl. CPC G05B 19/41865; G06Q 10/06316; G06Q 10/063116; G06Q 10/06313; G06Q 10/063114; G06Q 10/06312

(57) ABSTRACT

According to an embodiment, a computer-implemented method of identifying delay causing product assembly jobs in a factory that produces multiple products includes acquiring delay times for each of a plurality of jobs performed for assembly of each of a plurality of products at the factory, ranking the jobs according to a number of products affected by delay times, whereby a ranked jobs list is produced, adjusting at least one of a delay threshold, a job rank threshold, or a number of products threshold until a plot of amount of products affected by a delay exceeding the delay threshold as a dependent variable, versus ranked jobs of the ranked jobs list as an independent variable, exceeds the number of products threshold at the job rank threshold, and outputting an initial segment of the ranked jobs list up to the job rank threshold.

### FIELD

This disclosure relates generally to managing product manufacture.

### BACKGROUND

Manufacture of products, such as airplanes, typically occurs at a production facility such as a factory. A factory may produce a number of different products. Each product may transfer from one job station to another until all jobs are completed. Multiple jobs may be performed at each job station.

Sometimes products linger at job stations longer than anticipated. Such situations can cause production delays, which may reduce competitive advantages for the manufacturer and disappoint customers.

### SUMMARY

According to various embodiments, a computer-implemented method of identifying delay causing product assembly jobs in a factory that produces multiple products is disclosed. The method includes acquiring, by at least one electronic processor, delay times for each of a plurality of jobs performed for assembly of each of a plurality of products at the factory; ranking, by at least one electronic processor, the jobs according to a number of products affected by delay times, such that a ranked jobs list is produced; adjusting, by at least one electronic processor, at least one of a delay threshold, a job rank threshold, or a number of products threshold until a plot, of amount of products affected by a delay exceeding the delay threshold as a dependent variable, versus ranked jobs of the ranked jobs list as an independent variable, exceeds the number of products threshold at the job rank threshold; and outputting, by at least one electronic processor, an initial segment of the ranked jobs list up to the job rank threshold.

Various optional features of the above embodiments include the following. The method may include implementing at least one quality control improvement on at least one job in the initial segment of the ranked jobs list; and repeating the acquiring, ranking, adjusting, and outputting at least once. The method may include displaying a depiction of average delay per product as a dependent variable versus number of affected products as an independent variable; and animating the depiction to represent results of the implementing and repeating. The delay times may include one of: duration delays, end time delays, or start time delays. The method may include displaying a plurality of plots as decreasing curves for a plurality of delay threshold values. The products may be aircraft. The plurality of jobs may be at a single physical job station. The outputting may include causing to be displayed. The method may include performing a word analysis on descriptions of jobs in the initial segment of the ranked jobs to identify at least one common word. The adjusting may include holding the job rank threshold and the amount of affected products threshold fixed and adjusting the delay threshold.

According to various embodiments, a computer-implemented system for identifying delay causing product assembly jobs in a factory that produces multiple products is presented. The system includes at least one electronic processor configured to: acquire delay times for each of a plurality of jobs performed for assembly of each of a plurality of products at the factory; rank the jobs according to a number of products affected by delay times, such that a ranked jobs list is produced; adjust at least one of a delay threshold, a job rank threshold, or a number of products threshold, until a plot of amount of products affected by a delay exceeding the delay threshold as a dependent variable, versus ranked jobs of the ranked jobs list as an independent variable, exceeds the number of products threshold at the job rank threshold; and output an initial segment of the ranked jobs list up to the job rank threshold.

Various optional features of the above embodiments include the following. The at least one electronic processor may be further configured to: implement at least one quality control improvement on at least one job in the initial segment of the ranked jobs list; and repeatedly acquire, rank, adjust, and output at least once. The at least one electronic processor may be further configured to: display a depiction of average delay per product as a dependent variable versus number of affected products as an independent variable; and animate the depiction to represent results of repeatedly acquiring, ranking, adjusting, and outputting. The delay times may include one of: duration delays, end time delays, or start time delays. The at least one electronic processor may be further configured to: cause a display of a plurality of plots as decreasing curves for a plurality of delay threshold values. The products may be aircraft. The plurality of jobs may be at a single physical job station. The at least one electronic processor may be configured to output by causing to be displayed. The at least one electronic processor may be further configured to perform a word analysis on descriptions of jobs in the initial segment of the ranked jobs to identify at least one common word. The at least one electronic processor may be further configured to adjust by holding the job rank threshold and the amount of affected products threshold fixed and adjusting the delay threshold.

### BRIEF DESCRIPTION OF THE DRAWINGS

Various features of the examples can be more fully appreciated, as the examples become better understood with reference to the following detailed description, when considered in connection with the accompanying figures, in which:

FIG. 1 is a plot of mean average delays per aircraft as a dependent variable versus jobs as an independent variable;

FIG. 2 illustrates a table of delay durations for each of a number of jobs within a job station;

FIG. 3 is a graph illustrating a number of plots of delay-affected aircraft as a dependent variable versus jobs as an independent variable for a variety of delay thresholds;

FIG. 4 is a graph illustrating a plot corresponding to the 0.1 day delay threshold plot of FIG. 3;

FIG. 5 is a graph illustrating a plot corresponding to the 2.5 day delay threshold plot of FIG. 3;

FIG. 6 is a flowchart of a method of determining problematic jobs according to some embodiments;

FIG. 7 depicts an example word analysis for identifying common delay-causing tasks;

FIG. 8 is a flowchart depicting a method of implementing a method of determining problematic jobs and remediating associated delay-causing problems;

FIG. 9 shows a dashboard interface including a depiction of, for a number of jobs depicted as dots, the average delay per product animated within a space partitioned by high and low average delays, and high, medium and low number of affected products; and

FIG. 10 is a schematic diagram of a system suitable for implementation of a method as shown and described.

### DESCRIPTION

Reference will now be made in detail to the disclosed examples, which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific examples. These examples are described in sufficient detail to enable those skilled in the art to practice them and it is to be understood that other examples may be utilized and that changes may be made without departing from the scope of the disclosure. The following description is, therefore, merely exemplary.

Disclosed are data analytics techniques for identifying and correcting production bottlenecks. Such techniques may be used to decrease production backlog and increase production rates. The techniques are presented herein within the context of aircraft production as an example use case. However, the disclosed techniques apply equally well to other factory production environments (e.g., automobiles, ships, trucks, electronic devices, etc.) where similar data are available and collected.

In one example, the scale of the problem addressed by some embodiments may be illustrated by studying a particular aircraft job station. The studied job station is part of a process for assembling a wing on a passenger jet aircraft. There are about 300 individual jobs at the studied job station. By considering, for purposes of illustration, a delay as the difference between an actual job duration and the scheduled job durations, the compounding effect of delays affecting the production line at this particular job station may be estimated. Over a sample of 300 recent airplanes, the number of delay days for this one particular job station was found to be 89,760 days, or 246 years. Clearly, much of the work is done in parallel, so the net production delay is much less, but the costs associated with those delays are additive and include the unnecessary cost of carrying inventory during the added delay time. Moreover, there are 117 job stations, including about 13,500 required jobs that are used to assemble the studied aircraft. The scope of the problem is therefore large. Delays may impair a manufacturer's ability to meet customer demand and favor the manufacturer's competitor.

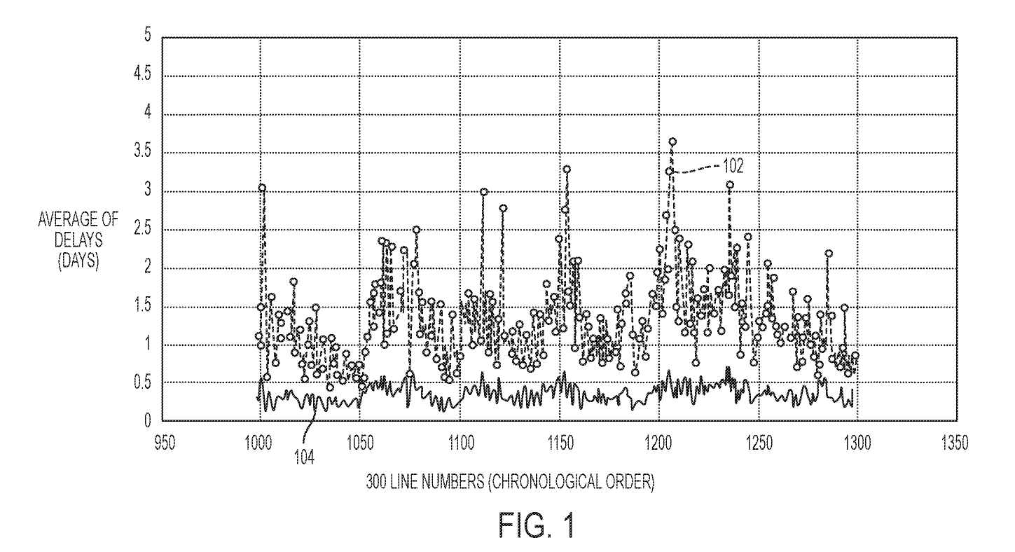

FIG. 1 is a plot 102 of mean delays per aircraft as a dependent variable versus jobs as an independent variable. The jobs are represented along the x-axis according to chronological order of completion during the manufacturing process. Mean delays are represented on the y-axis. In particular, plot 102 illustrates delays averaged over 300 implemented job completions. Also shown is plot 104 of standard deviation for the over 300 implemented job completions. These plots suggest that duration-delay problems are systemic as well as attributed to isolated events. Both types seem to be persistent without clear evidence of improvement over time. Further, the average delays above the mean delay value of 1.29 days point mostly to isolated events (i.e., outliers) and the points below it point to systemic delays. Although it is possible that individual delay contributing problems are resolved over the short term, there is no consistent evidence of improvement in the reduction of delays over the long term.

The delays may be the result of inefficiencies inherent in the jobs that factory managers and mechanics have little time to identify and implement the necessary quality control improvements. Due to the production schedule demands, the production engineering groups that support the work on the factory floor are typically preoccupied with trying to help tackle the issues of the day with little to no resources left to address the broader process control issues. Furthermore, those issues are many and are pervasive, making it difficult to prioritize and assess their relative impact.

Accordingly, production environments would greatly benefit from a methodology that prioritizes, guides the identification of root causes, and helps allocate resources to make the necessary quality control improvements where they are needed most. Some embodiments continuously generate a manageable, prioritized, short list of the most impacting jobs introducing the longest delays and affecting the largest number of products. With the magnitude and scale of the quality control problem, it becomes critically important to know which problem to tackle first, and which, next. Some embodiments provide such information.

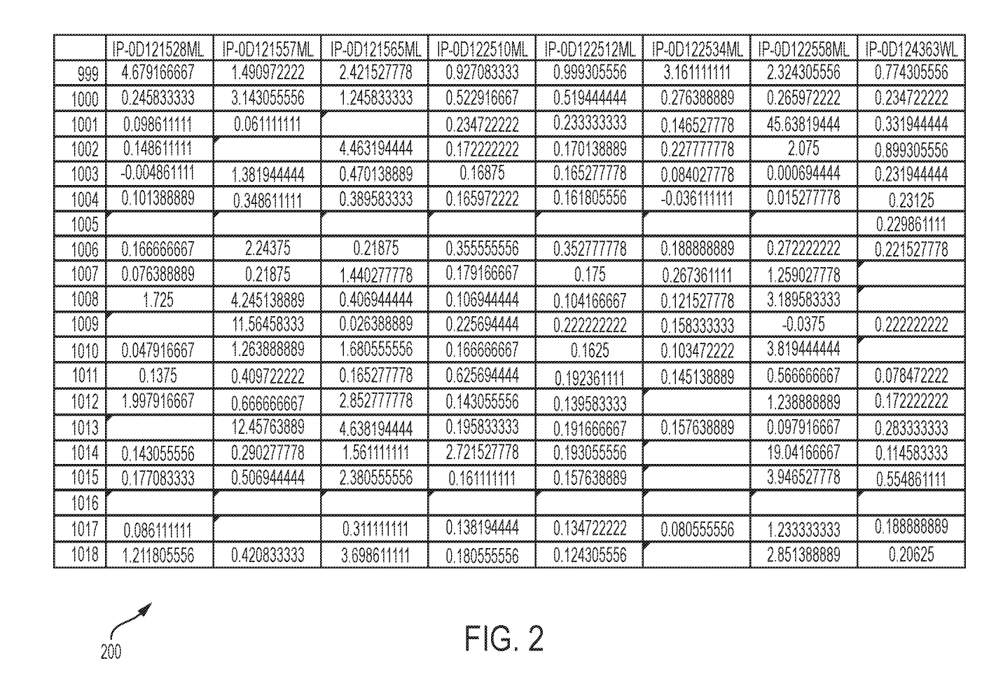

FIG. 2 illustrates a table 200 of delay durations for each of a number of jobs within a job station. Each row represents an individual airplane as it is operated on at the job station. The rows are ordered chronologically, by the order in which the airplanes were processed at the job station. Each column represents a different job at the represented job station. Thus, while the rows are ordered chronologically, the columns would benefit from being ordered in a manner that is conducive to the identification of useful data patterns. Useful patterns may be used to identify short, manageable, and prioritized lists of the most problematic jobs. Thus, according to some embodiments, the jobs are ordered by decreasing number of airplanes affected by the delays. Using this ordering, some embodiments prioritize and select, for a given job station, the pattern that allows for identifying a small number of jobs suffering delays that affect the largest number of airplanes. By choosing a suitable set of parameters, a priori, some embodiments may automatically identify, for example, the 5% of jobs that affect more than 50% of the airplanes.

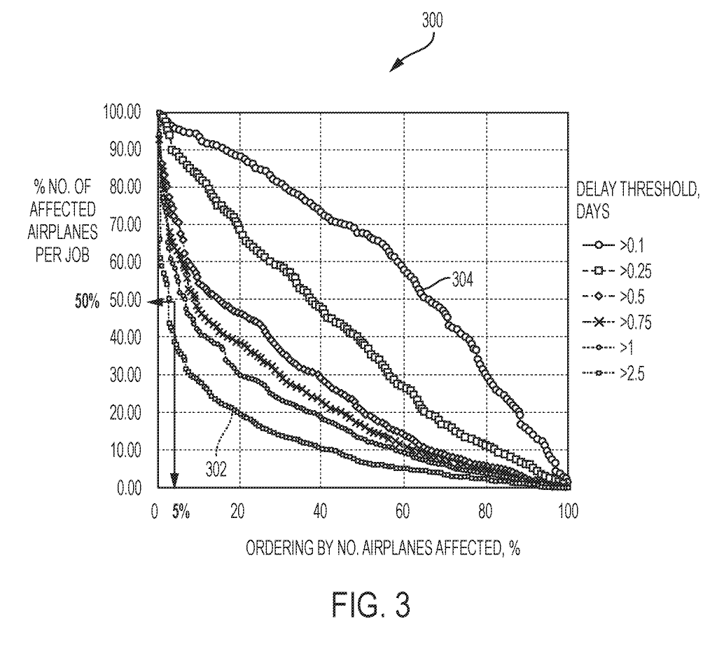

FIG. 3 is a graph 300 illustrating a number of plots of delay-affected aircraft as a dependent variable versus jobs as an independent variable for a variety of delay thresholds. Thus, graph 300 represents the percentage of delay-affected aircraft on the y-axis, and represents delay-suffering jobs, ordered according to number of delay-affected aircraft and scaled as a percentage, on the x-axis. Each plot in graph 300 corresponds to a different delay threshold. For example, plot 302 corresponds to a delay threshold of at least two and one-half days. As shown in FIG. 3, for a delay threshold of 2.5 days, the first 5% of jobs, decreasingly ordered according to percentage of delay-affected aircraft, account for delays affecting more than 50% of the airplanes. That is, the first 5% of jobs affect 50% of the aircraft with delays of at least 2.5 days. In contrast, plot 304 corresponds to a delay of at least one-tenth of one day. As shown in FIG. 3, for a delay threshold of 0.1 day, the first 80% of the jobs, decreasingly ordered according to percentage of delay-affected aircraft, are identified as affecting just 5% of the aircraft. That is, the first 80% of the jobs affect 50% of the aircraft with delays of at least one-tenth of one day.

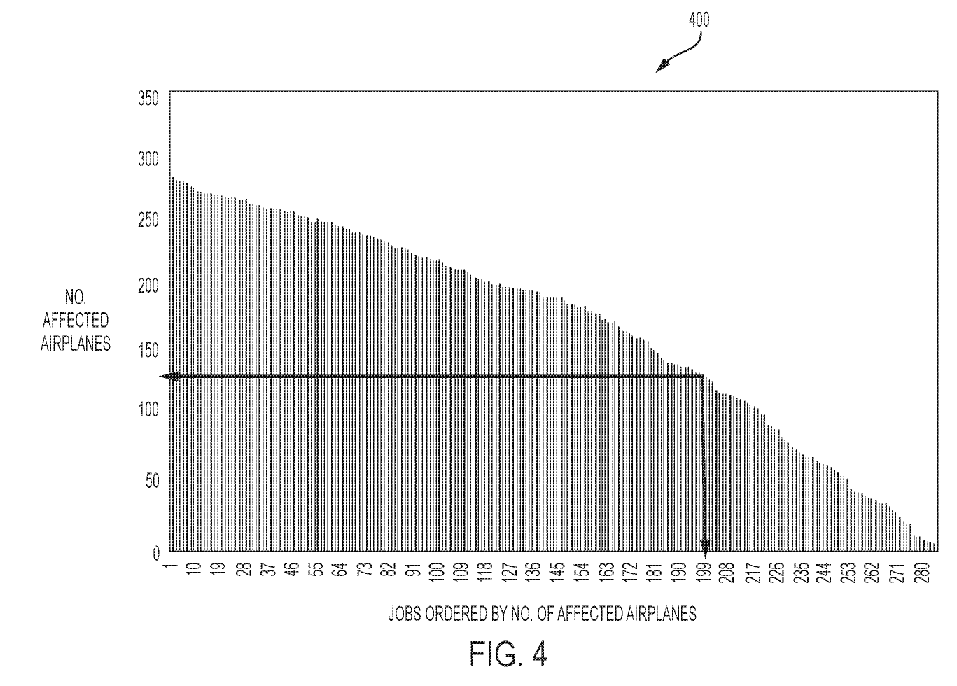

FIG. 4 is a graph 400 illustrating a plot corresponding to the 0.1 day delay threshold plot 302 of FIG. 3. As with graph 300 of FIG. 3, the x-axis of graph 400 represents jobs, decreasingly ordered according to number of delay-affected aircraft. In contrast to graph 300 of FIG. 3, the jobs are not scaled as a percentage, but rather enumerated from one to 285. Likewise, as with graph 300 of FIG. 3, the y-axis of graph 400 represents number of delay-affected aircraft. Also in contrast to graph 300 of FIG. 3, the delay-affected aircraft are represented in gross numbers from zero to 280, rather than a percentage. With the graph scaling and information understood, it is seen that an amount of affected products threshold of 0.1 day identifies too many jobs (about 200) for an affected aircraft threshold of 140, i.e., 50%.

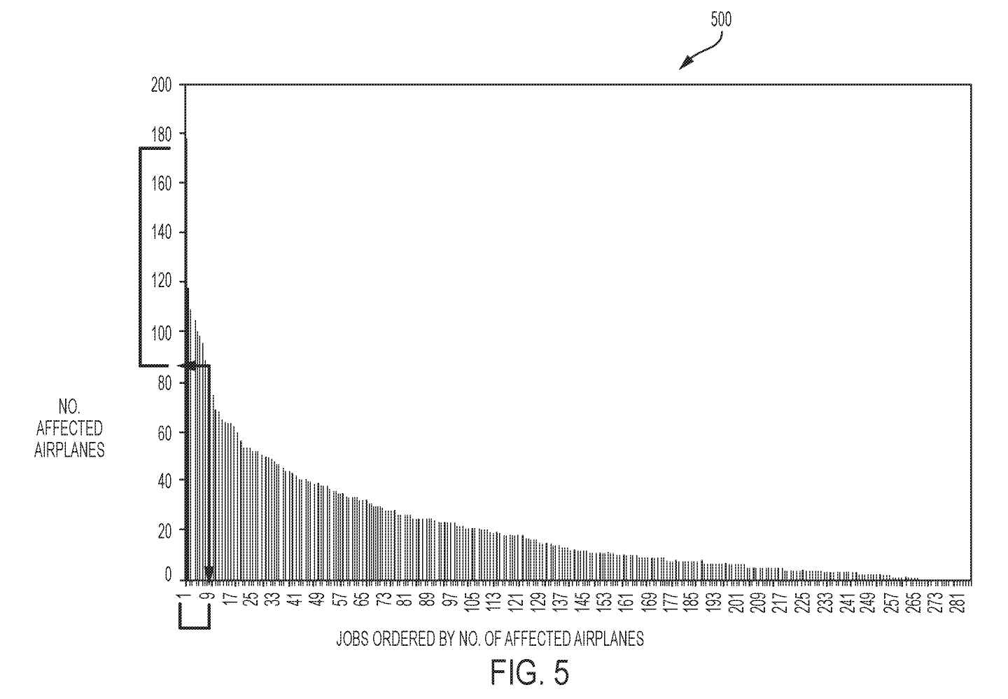

FIG. 5 is a graph 500 illustrating a plot corresponding to the 2.5 day delay threshold plot 304 of FIG. 3. The axes of graph 500 represent the same scaling and information as the axes of graph 400 of FIG. 4. As shown, the first approximately 14 jobs, when decreasingly ordered according to number of delay-affected aircraft, account for delays that affect approximately 85 of the 178 aircraft studied. Accordingly, graph 500 can be used to identify a short list of jobs that should be exposed to quality control improvements in order to reduce delays affecting more than half the airplanes.

The plots of FIGS. 4 and 5 distinguish between the selected delay threshold of the plot of FIG. 5, which results in a desirable short list of jobs with high delay impact, as opposed to the selected delay threshold of the plot of FIG. 4, which results in an undesirably long list of jobs. The job list of FIG. 4, while still impacting a large number of airplanes, is less practical than the list generated by the plot of FIG. 5 because of the large number of jobs.

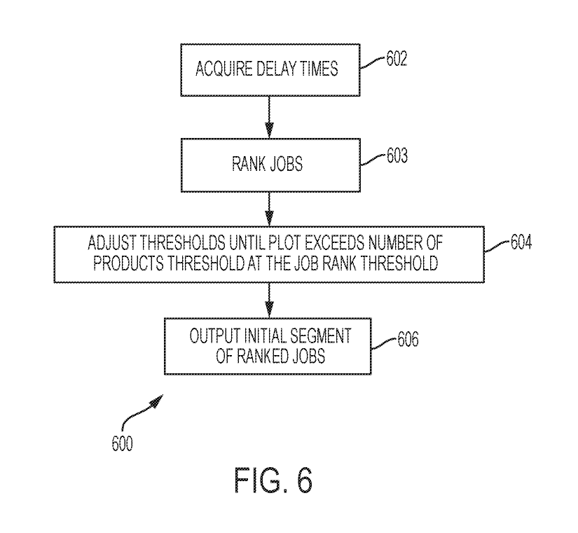

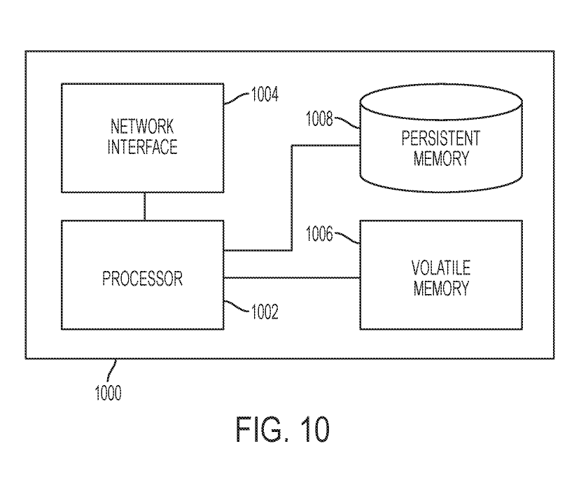

FIG. 6 is a flowchart of a method 600 of determining problematic jobs according to some embodiments. The method may be implemented using hardware as shown and described in reference to FIG. 10, below, for example.

At block 602, method 600 acquires delay times for each of a plurality of jobs performed for assembly of each of a plurality of products at a manufacturing facility. Method 600 may acquire the delay times in a variety of ways. According to some embodiments, method 600 may acquire delay times via a network interface. According to some embodiments, method 600 may acquire the delay times by entry through a user interface. According to some embodiments, method 600 may acquire the delay times by retrieval from persistent electronic storage.

The delay times may be measured according to any of a variety of conventions. According to some embodiments, the delay times represent end time delays, that is, time in excess of scheduled end times. According to some embodiments, the delay times represent start time delays, that is, differences between scheduled start times and actual start times. According to some embodiments, the delay times represent end time delays, that is, differences between scheduled end times and actual end times. Other delay times are also possible. Essentially any delay time that represents a job taking longer than anticipated may be suitable according to some embodiments.

The delay times acquired at block 602 may be stored in persistent memory, e.g., in a database. For example, the delay times may be stored in a database table, with each column in the table represented delay times for a different job. Multiple job stations may be represented by multiple tables, for example.

At block 603, method 600 ranks the jobs for according to the number of products affected. More particularly, at block 603, method 600 ranks the jobs for which delay times were acquired at block 602 according to number of delay-affected products as shown and described above in reference to FIGS. 3-5. The ranking may be in descending order, for example. The jobs may be ranked using a sorting algorithm, such as bubble sort, heap sort, or merge sort, for example. The ranking may be stored in persistent or volatile memory according to some embodiments.

At block 604, method 600 adjusts one or more thresholds until a plot in the manner of FIGS. 3-5 exceeds the number of products threshold at the job rank threshold. More particularly, the method adjusts one or more of a delay threshold, a job rank threshold, or a number of products threshold until a plot of amount of products affected by a delay exceeding the delay threshold as a dependent variable, versus the descendingly-ordered ranked jobs of block 603 as an independent variable, exceeds the number of products threshold at the job rank threshold. These actions are explained further below.

To accomplish the actions of block 604, method 600 may produce a plot or data representing a plot. The plot is a plot in the manner of FIGS. 3-5, with the x-axis representing the ranked jobs of block 603 arranged in a descending manner, that is, by decreasing order of number of delayed products. The x-axis may be arranged as a percentage or by number, for example. The y-axis may represent amount (e.g., percentage, number, etc.) of delayed products. The plot may be displayed to a user as part of this block, or may not be displayed.

The delay threshold represents the amount of delay that a job must be affected by in order to be plotted on the plot. The job rank threshold represents an x-axis position, and the number of products threshold represents a y-axis position. Per block 604, one or more of the thresholds are adjusted until the y-axis value of the plot at the job rank threshold x-axis position exceeds the number of products threshold. The resulting situation is referred to herein as the “satisfaction condition”.

The thresholds may be selected as follows. According to some embodiments, a user selects at least initial values for the thresholds, e.g., inputting them into a user interface. This may proceed by the user first selecting the job rank threshold and the number of products thresholds, and then adjusting the delay threshold until the satisfaction condition holds. The user may also select an initial value for the delay threshold, or the system may select such an initial value. The user may adjust the delay threshold, or the system implementing method 600 may adjust the delay threshold. The system may select initial values for the job rank threshold and the number of products thresholds according to some embodiments.

Suitable values for the job rank threshold and number of products threshold include, e.g., 5% and 50%, respectively. A consideration in selecting values for these parameters is that the job rank threshold should be relatively small (e.g., ten percent or less, or 20 jobs or less in gross numbers when considering airplanes) and the number of products threshold should be relatively large (e.g., 40% or more, or 100 products or more when considering airplanes). These values are exemplary; other values may be selected and employed.

The parameters may be adjusted as follows. According to some embodiments, the user adjusts the values of one or more parameters, e.g., by inputting or re-inputting values for them. According to some embodiments, the system implementing method 600 adjusts one or more threshold values. The threshold values may be changed by increments. The increments may be 1%, 2%, 5%, 10%, 15%, etc. Other increments are possible.

According to some embodiments, the system that implements method 600 may adjust the thresholds in a lexicographic fashion as follows. The system may fix the number of products threshold and the job rank threshold, and decrease the delay threshold incrementally. If the delay threshold reaches some lower bound, e.g., two hours, then the number of products threshold is incremented once, the job rank threshold is decremented once, or both, and then the delay threshold is reset and repeatedly decremented as before. If it again reaches the lower bound, then either or both of the number of products threshold and job rank threshold is adjusted once, and the process is repeated as before.

At the end of the process of block 604, method 600 has obtained a job rank threshold such that the plot at that x-axis value exceeds the number of products threshold on the y-axis.

At block 606, method 600 outputs an initial segment of the ranked jobs list. The initial segment may be the first few jobs of the ranked jobs list up to the job rank threshold output by block 604. The output may be of various forms. According to some embodiments, the output is by way of displaying on a computer monitor of the system that implements method 600. According to some embodiments, the output is by way of an email sent to one or more designated users. According to some embodiments, the format of the output is by way of job identification codes. According to some embodiments, the format of the output is the job names and/or descriptions.

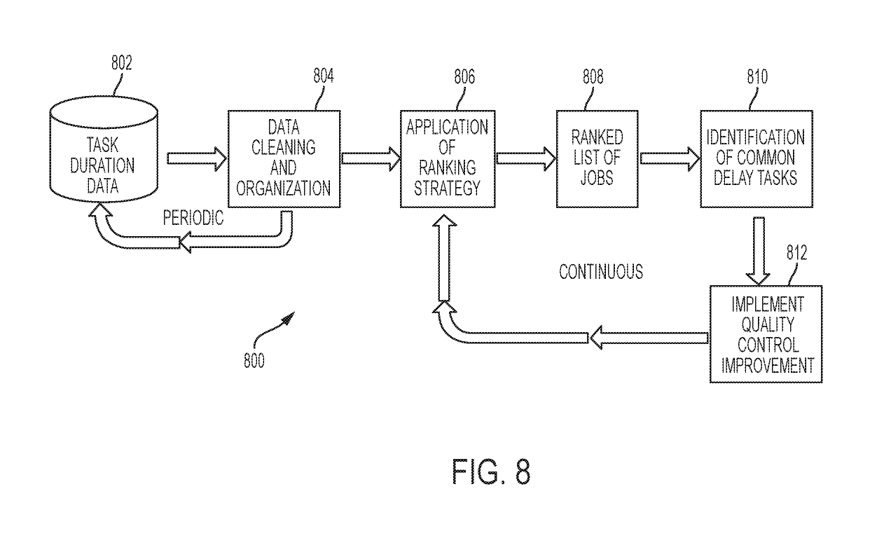

Once the initial segment of the ranked jobs list is output, quality control measures may be implemented for the jobs in the output. This may be performed once, or, according to some embodiments, repeatedly, as shown and described in reference to FIG. 8, below. First, however, this document describes how common delay-causing tasks may be identified using the output of method 600.

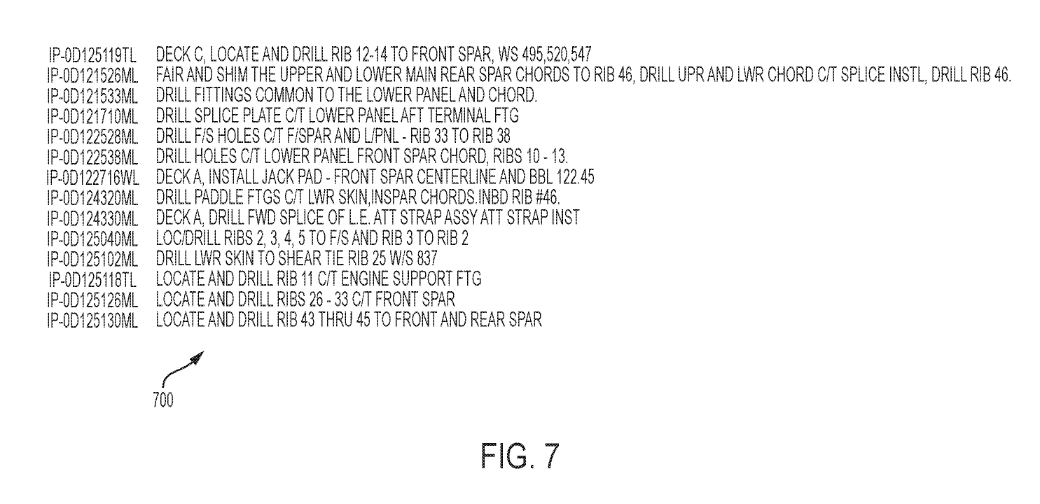

FIG. 7 depicts an example word analysis 700 for identifying common delay-causing tasks. According to some embodiments, job descriptions of the ranked job list initial segment output by method 600 are analyzed for frequent words and/or phrases. Stop words, such as articles (“a”, “the”, etc.) and prepositions (“in”, “on”, etc.) may be removed from the results. The results may provide a list of words and phrases whose occurrence in a job description may indicate a risk of delay. As shown in FIG. 7, common phrases from an output initial segment of the ranked list of words include “ribs”, “lower panel”, and “drill”. A full list of job descriptions was then searched for these phrases, and the resulting list of hits appears in FIG. 7. Thus, the jobs whose descriptions include one or more of the identified words or phrases may receive special scrutiny and/or be subjected to quality control techniques in order to reduce or prevent delays.

FIG. 8 is a flowchart depicting a method 800 of implementing a method of determining problematic jobs (e.g., method 600) and remediating associated delay-causing problems. At block 802, method 800 obtains task duration data (e.g. job delay information). The actions of this block are essentially the same as those of block 602 of method 600. At block 804, the data of block 802 are cleaned to remove erroneous data and other errors and organized for input into method 600. This block may be implemented as part of block 602 of method 600. Thus, as shown in FIG. 8, method 800 may include periodic obtaining and cleaning of delay information.

At block 806, the delay information from blocks 802 and 804 is input to an application of a ranking strategy, e.g., method 600 of FIG. 6. The output of method 600, the identification of the jobs in the initial segment of the ranked jobs list, is obtained at block 808. Thus, blocks 806 and 808 may be considered as an implementation of method 600 of FIG. 6. At block 810, an identification of common delay tasks is undertaken. The identification may proceed using a word analysis, e.g., as shown and described in reference to FIG. 7, above. At block 812, method 800 implements quality control measures on the identified jobs of block 808 and/or block 810. After block 812, flow returns to block 806.

In sum, method 800 provides a way to obtain a list of problematic jobs and make it available to production engineering, on demand, for further analysis and creation of quality control improvements than will reduce or eliminate the inefficiencies producing the delays. Once those actions are implemented, the method may produce the next list of delay-causing jobs at each job station for resolving the next problem, in the most delay-impacting priority, to resolve. Implementation of this continuous quality improvement methodology will enable production engineering to systematically address the problems that are creating delays and adding to inventory cost in the order that has most impact to the production rate.

Once delay resolving issues are implemented, they may be monitored in a continuous basis to validate that improvement gains are realized for each job in each job station. A description of a technique for doing so follows.

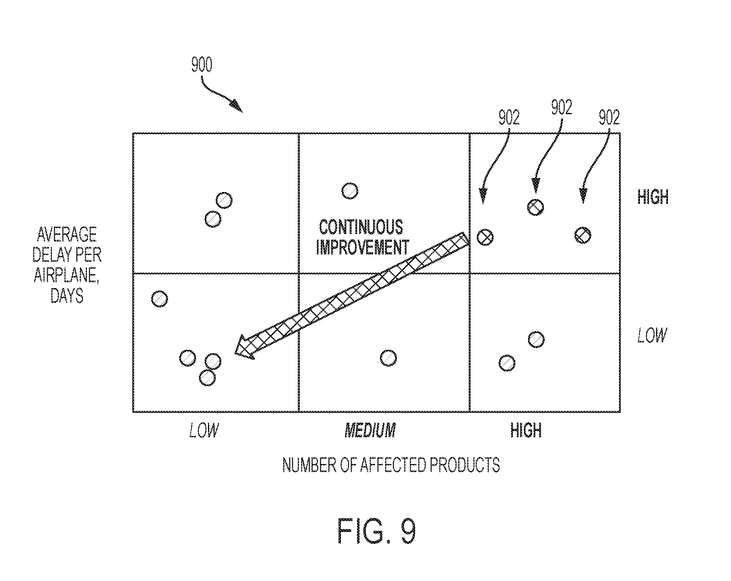

FIG. 9 shows a dashboard interface including a depiction 900 of, for a number of jobs depicted as dots 902, the average delay per product animated within a space partitioned by high and low average delays, and high, medium and low number of affected products. The method tracks the improvement gains realized by the reduction in average delay, for each job, from areas of high average delay affecting a high number of products, to areas of low average delay affecting a low number of products. The dashboard may be animated to depict a long timescale, e.g., on the order of weeks or months, in a short time span, e.g., five or ten seconds. The animation may depict dots 902 moving between the partitioned zones, thus evidencing improvement as a result of the implemented quality improvement processes. If the dots 902 fail to move as described, it may be concluded that the quality improvement techniques were not successful, and they may be adjusted and re-implemented.

FIG. 10 is a schematic diagram of a system 1000 suitable for implementation of a method as shown and described, e.g., method 600 and/or 800. System 1000 may be based around an electronic hardware internet server computer that include one or more electronic processors 1002, which may be communicatively coupled to the internet. System 1000 includes network interface 1004 to affect the communicative coupling to the internet. Network interface 1004 may include a physical network interface, such as a network adapter. System 1000 may be a special-purpose computer, adapted for reliability and high-bandwidth communications. Thus, system 1000 may be embodied in a cluster of individual hardware server computers, for example. Processors 1002 may be multi-core processors suitable for handling large amounts of information. One or more processors 1002 are communicatively coupled to persistent memory 1008, and may execute instructions stored thereon to effectuate the techniques disclosed herein as shown and described in reference to FIGS. 6 and 8. Processors 1002 are also communicatively coupled to volatile memory 1006. Persistent memory 1008 may be in a Redundant Array of Inexpensive Disk drives (RAID) configuration for added reliability, and volatile memory 1006 may be or include Error-Correcting Code (ECC) memory hardware devices.

Certain examples described above can be performed in part using a computer application or program. The computer program can exist in a variety of forms, both active and inactive. For example, the computer program can exist as one or more software programs, software modules, or both, that can be comprised of program instructions in source code, object code, executable code or other formats, firmware program(s), or hardware description language (HDL) files. Any of the above can be embodied on a computer readable medium, which can include computer readable storage devices and media in compressed or uncompressed form. Exemplary computer readable storage devices and media include conventional computer system RAM (random access memory), ROM (read-only memory), EPROM (erasable, programmable ROM), EEPROM (electrically erasable, programmable ROM), and magnetic or optical disks or tapes.

Those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A computer-implemented method (600) of identifying delay causing product assembly jobs in a factory that produces multiple products, the method comprising:
acquiring (602), by at least one electronic processor, delay times (802) for each of a plurality of jobs performed for assembly of each of a plurality of products at the factory;
ranking (603), by at least one electronic processor, the jobs according to a number of products affected by delay times, whereby a ranked jobs list is produced;
adjusting (604), by at least one electronic processor, at least one of a delay threshold, a job rank threshold, or a number of products threshold until a plot (302, 304), of amount of products affected by a delay exceeding the delay threshold as a dependent variable, versus ranked jobs of the ranked jobs list as an independent variable, exceeds the number of products threshold at the job rank threshold; and
outputting (606), by at least one electronic processor, an initial segment of the ranked jobs list up to the job rank threshold.

2. The method of claim 1, further comprising:
implementing (812) at least one quality control improvement on at least one job in the initial segment of the ranked jobs list; and
repeating (800) the acquiring, ranking, adjusting, and outputting at least once.

3. The method of claim 2, further comprising:
displaying a depiction (900) of average delay per product as a dependent variable versus number of affected products as an independent variable; and
animating the depiction to represent results of the implementing and repeating.

4. The method of claim 1, wherein the delay times comprise one of:
duration delays, end time delays, or start time delays.

5. The method of claim 1, further comprising displaying a plurality of plots (302, 304) as decreasing curves for a plurality of delay threshold values.

6. The method of claim 1, wherein the products are aircraft.

7. The method of claim 1, wherein the plurality of jobs are at a single physical job station.

8. The method of claim 1, wherein the outputting comprises causing to be displayed.

9. The method of claim 1, further comprising performing a word analysis (700) on descriptions of jobs in the initial segment of the ranked jobs to identify at least one common word.

10. The method of claim 1, wherein the adjusting comprises:
holding the job rank threshold and the amount of affected products threshold fixed, and
adjusting the delay threshold.

11. A computer-implemented system (1000) for identifying delay causing product assembly jobs in a factory that produces multiple products, the system comprising at least one electronic processor (1002) configured to:
acquire (602) delay times (802) for each of a plurality of jobs performed for assembly of each of a plurality of products at the factory;
rank (603) the jobs according to a number of products affected by delay times, whereby a ranked jobs list is produced;
adjust (604) at least one of a delay threshold, a job rank threshold, or a number of products threshold until a plot (302, 304), of amount of products affected by a delay exceeding the delay threshold as a dependent variable, versus ranked jobs of the ranked jobs list as an independent variable, exceeds the number of products threshold at the job rank threshold; and
output (606) an initial segment of the ranked jobs list up to the job rank threshold.

12. The system of claim 11, wherein the at least one electronic processor is further configured to:
implement (812) at least one quality control improvement on at least one job in the initial segment of the ranked jobs list; and
repeatedly (800) acquire, rank, adjust, and output at least once.

13. The system of claim 12, wherein the at least one electronic processor is further configured to:
display a depiction (900) of average delay per product as a dependent variable versus number of affected products as an independent variable; and
animate the depiction to represent results of repeatedly acquiring, ranking, adjusting, and outputting.

14. The system of claim 11, wherein the delay times comprise one of:
duration delays, end time delays, or start time delays.

15. The system of claim 11, wherein the at least one electronic processor is further configured to: cause a display of a plurality of plots (302, 304) as decreasing curves for a plurality of delay threshold values.

16. The system of claim 11, wherein the products are aircraft.

17. The system of claim 11, wherein the plurality of jobs are at a single physical job station.

18. The system of claim 11, wherein the at least one electronic processor is configured to output by causing to be displayed.

19. The system of claim 11, wherein the at least one electronic processor is further configured to perform a word analysis (700) on descriptions of jobs in the initial segment of the ranked jobs to identify at least one common word.

20. The system of claim 11, wherein the at least one electronic processor is further configured to adjust by holding the job rank threshold and the amount of affected products threshold fixed and adjusting the delay threshold.
